(19) United States
(12) Patent Application Publication
(10) Pub. No.: US 2024/0160187 A1
(43) Pub. Date: May 16, 2024

(54) OPTIMIZING MANUFACTURING PLANT DEVICES

(71) Applicant: Andritz Inc., Alpharetta, GA (US)

(72) Inventors: Verena GISSING, Vienna (AT); Patrick LEUK, Vienna (AT)

(21) Appl. No.: 18/281,724

(22) PCT Filed: Mar. 24, 2021
(86) PCT No.: PCT/US2021/023952

§ 371 Date: Sep. 12, 2023

(51) Int. Cl. G05B 19/418

(52) U.S. Cl. CPC G05B 19/41835; G05B 2219/36289

(57) ABSTRACT

Methods, systems, and apparatus, including computer programs encoded on a computer storage medium, that can optimize a manufacturing plant's operations and/or production based on simulations that utilize information about the current and forthcoming manufacturing conditions to determine the optimal operational characteristics for the different plant devices. Methods may include obtaining, using data from a set of sensors, a set of current operational characteristics for multiple plant devices in a plant. Multiple manufacturing scenarios can be simulated using different sets of operational characteristics for plant devices in which at least one operational characteristic from the set of current operational characteristics is varied. A first manufacturing scenario can be determined that satisfies overall operational parameter(s) for one or more plant devices or for the whole manufacturing plant. Setting(s) of one or more plant devices can be adjusted based on a set of operational characteristics corresponding to the first manufacturing scenario.

### BACKGROUND

This specification generally relates to optimizing a manufacturing plant's devices.

Manufacturing plants (e.g., paper processing plants, metal processing plants) utilize several different types of manufacturing devices (e.g., refiners, pellet mills, centrifuges, drills, etc.) as well as other devices (e.g., control systems, transformers, electrical systems, etc.) (collectively referred to as “plant devices”) to perform manufacturing/production operations. These plant devices generally include electrical, mechanical, and/or computing components. In some instances, plant devices may be operating normally but not as efficiently or effectively as they could. In such instances, adjusting these plant devices, if they can be identified, could potentially result in an increase in a target plant manufacturing output (or another target for a plant overall operational parameter) for the manufacturing plant. In other instances, plant devices may need to be adjusted from time-to-time for different operational reasons, such as, e.g., planning a plant shutdown, making repairs, performing service, installing new devices, or bringing the operation of an out-of-specification device within specification. In such instances, an operator's adjustment of one or more plant device may not result in meeting or exceeding a target plant manufacturing output (or another plant overall operational parameter) for the manufacturing plant. And in some instances, an operator's adjustment of one or more plant devices can have a negative impact on the plant's manufacturing output (or another plant overall operational parameter). For example, performing a service on a plant device when the device is operating normally and is expected to operate normally for a certain period may prevent a plant from meeting its target manufacturing output.

### SUMMARY

In general, one innovative aspect of the subject matter described in this specification can be embodied in methods that can include the actions of obtaining, using data from a set of sensors, a set of current operational characteristics for a plurality of plant devices in a manufacturing plant; simulating a plurality of manufacturing scenarios using different sets of operational characteristics for plant devices in which at least one operational characteristic from the set of current operational characteristics is varied; determining, from among the simulated manufacturing scenarios, a first manufacturing scenario that satisfies one or more overall operational parameters for one or more plant devices or for the manufacturing plant as a whole; and adjusting one or more settings of one or more plant devices based on a set of operational characteristics corresponding to the first manufacturing scenario. Other embodiments of this aspect include corresponding systems, apparatus, and computer programs, configured to perform the actions of the methods, encoded on computer storage devices.

These and other embodiments can each optionally include one or more of the following features.

In some implementations, methods can include generating a visualization that presents the set of operational characteristics corresponding to the first manufacturing scenario.

In some implementations, simulating the plurality of manufacturing scenarios can be based on one or more factors that include: a plant operational capacity; operational ranges for plant devices; actual and expected degradations in plant device efficiency; or actual and expected manufacturing plant or plant device shutdowns.

In some implementations, determining, from among the simulated manufacturing scenarios, the first manufacturing scenario, can include determining, from among the simulated manufacturing scenarios, the first manufacturing scenario that achieves a plant manufacturing output that is greater than plant manufacturing outputs achieved by other simulated manufacturing scenarios.

In some implementations, methods can include transmitting information regarding the first manufacturing scenario that achieves the target plant manufacturing output and the one or more settings of the one or more plant devices to a plant operator device; receiving, from the plant operator device, a message confirming that the one or more settings of the one or more plant devices can be adjusted.

In some implementations, adjusting one or more settings of one or more plant devices can only be performed in response to the message confirming that the one or more settings of plant devices can be adjusted.

Particular embodiments of the subject matter described in this specification can be implemented to realize one or more of the following advantages. As described in this specification, when a human makes an adjustment to a piece of equipment in a manufacturing plant, unintended consequences (e.g., detrimental effects to other devices or plant output) may occur, whereas the present innovations rely on simulations that can predict system-wide effects of a proposed change to a particular device prior to making the proposed change. The use of simulations in the determination as to the devices to change, and how to change them, eliminates the possibility of these negative effects that may exist following changes made without utilizing the techniques discussed in this document.

Moreover, this specification describes techniques that utilize sensors (e.g., motion sensors, sound sensors, vibration sensors, etc.) dispersed throughout a manufacturing plant (e.g., on or around different plant devices) that routinely collect operational information about different aspects of the plant. The collected sensor data can be processed, analyzed, and aggregated to obtain a real-time, holistic assessment of the plant's current operational state. Such holistic analysis of the plant's operations, as described in this specification, can be performed without negatively affecting the productivity of the plant.

Further still, the techniques described in this specification can make adjustments to plant operations (e.g., adjustments to one or more plant devices) in a manner that results in the plant's or the device's operational and/or manufacturing outputs being maintained or improved, in comparison to conventional techniques. Conventional techniques generally are not able to identify opportunities for operational improvements when the plant is operating at a normal state (e.g., plant's manufacturing output meets a target manufacturing output). In addition, conventional techniques also generally fail to maintain the plant's overall operational requirements (e.g., the target manufacturing output) despite an action that potentially affects the plant's operations (e.g., service, repair, etc.). In contrast, the techniques described in this specification achieve or exceed the plant's or the device's target manufacturing output (or another plant/device operational requirement) by performing various simulations that utilize information about the current and forthcoming conditions to identify and adjust the operational characteristics for particular different plant devices in a manner that achieves or exceeds the plant/device operational requirement. As a result, the techniques described in this specification can simulate plant's operations for different manufacturing scenarios to, e.g., identify scenarios in which the plant manufacturing output can be increased by certain amount/percentage (e.g., from 90% to 95%) or adjust the plant's operations in view of a particular adjustment (e.g., servicing a device or planning a plant shutdown) to maintain the current plant manufacturing output over a certain period. Based on these simulations, the techniques described in this specification can then adjust the plant's operations (e.g., adjustments to one or more plant devices) in accordance with the simulated scenarios to maintain and/or improve the plant's manufacturing output.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for monitoring and adjusting the operations of a manufacturing plant.

FIG. 2 is a block diagram illustrating the components of FIG. 1 that operate together to determine adjustments to one or more plant devices that results in maintaining and/or exceeding an overall plant operational requirement.

FIG. 3 is a block diagram of an example environment in which the plant management system optimizes operations of a plant based on a future event that could affect plant operations.

FIG. 4 is a flow chart of an example process for determining adjustments to one or more plant devices that results in maintaining and/or exceeding an overall plant operational requirement.

FIG. 5 is an example user interface visualization that is generated for presentation on an operator device.

FIG. 6 is a block diagram of a computing system that can be used in connection with methods described in this specification.

Like reference numbers and designations in the various drawings indicate like elements.

### DETAILED DESCRIPTION

This document generally relates to techniques for optimizing a manufacturing plant's operations and/or production based on simulations that utilize information about the current and forthcoming manufacturing conditions to determine the optimal operational characteristics for the different plant devices. As used throughout this document, the terms optimize, optimized, optimizing, optimal, and other variations of these terms are used to convey an improvement over a reference state, and not necessarily the highest achievable state.

As further described below and in more detail throughout this specification, a plant management system collects and processes information from different types of sensors, such as, e.g., flow sensors, power sensors, etc., distributed throughout the manufacturing plant. The plant management system processes this sensor data to identify operational characteristics of the different plant devices in the plant. As used in this document, an “operational characteristic” refers to a characteristic of a manufacturing device that, when adjusted, affects the operation of the manufacturing device (or some component thereof) and can include, for example, speed, frequency, power input or output, percentage of valve opening, material flow rate, production rate, etc.

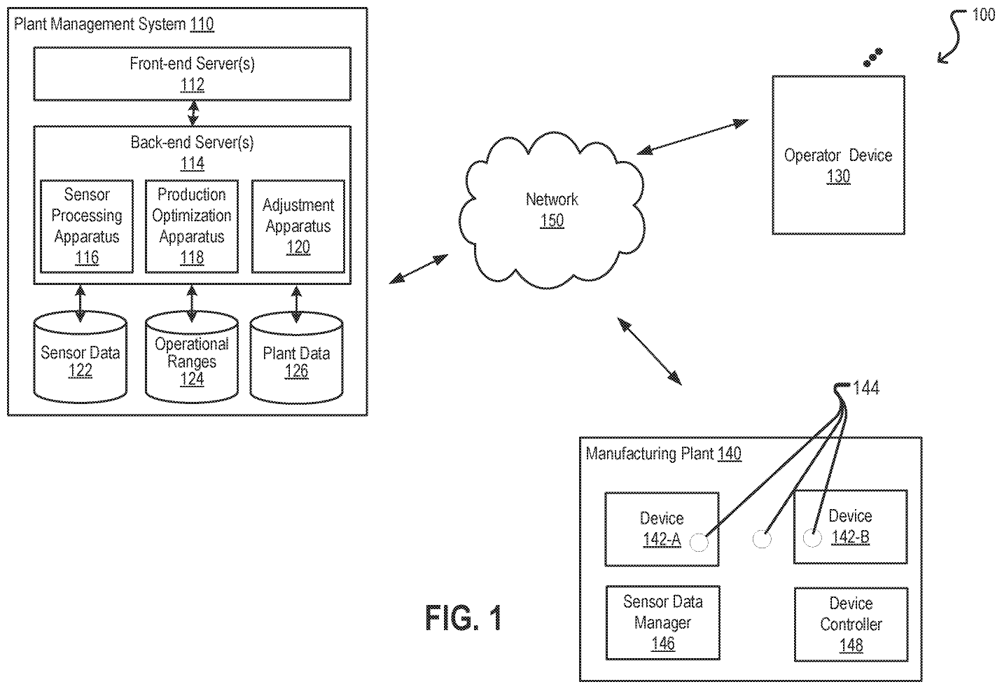

The plant management system executes multiple simulations to identify a manufacturing scenario in which one or more overall operational parameters (as further described with reference to FIGS. 1-3) can be maintained at the target level or improved beyond the target level of these parameters. The plant management system utilizes multiple sets of operational characteristics for different plant devices as well as additional information, such as operational data, and/or plant/device constraints information (e.g., maximum and minimum production rates/capacity, planned/actual shutdowns, etc.) to generate data for multiple manufacturing scenarios. From among these manufacturing scenarios, the plant management system identifies the manufacturing scenario in which one or more overall operational parameters are satisfied (e.g., manufacturing output of the plant or one or more devices is maintained at current levels or exceeds current levels).

For the identified manufacturing scenario, the plant management system identifies the operational characteristics for different plant devices corresponding to the manufacturing scenario. Using these operational characteristics for the different plant devices, the plant management system determines one or more adjustments to the settings of these devices.

In some instances, the plant management system can also generate a visualization (e.g., graphical representation), which can be accessed by plant operators at operator devices (e.g., computing devices). The visualization provides, for example, text and/or graphs (or other graphical information) describing and/or showing the current operational and risk reports, which identify the planned adjustment actions and/or operational characteristics that the plant management system is recommending for adjustment.

These and other features are more fully described in the descriptions below.

FIG. 1 is a block diagram of an example environment 100 in which a plant management system 110 monitors and adjusts the operations of a manufacturing plant.

The example environment 100 includes a network 150, such as a local area network (LAN), a wide area network (WAN), the Internet, a mobile network, or a combination thereof. The network 150 connects the plant management system 110, one or more operator devices 130, and one or more manufacturing plants 140. Although the below description describes a single manufacturing plant 140 being controlled/monitored by the plant management system 110, in some implementations, multiple manufacturing plants 140 may be controlled/monitored by the plant management system 110.

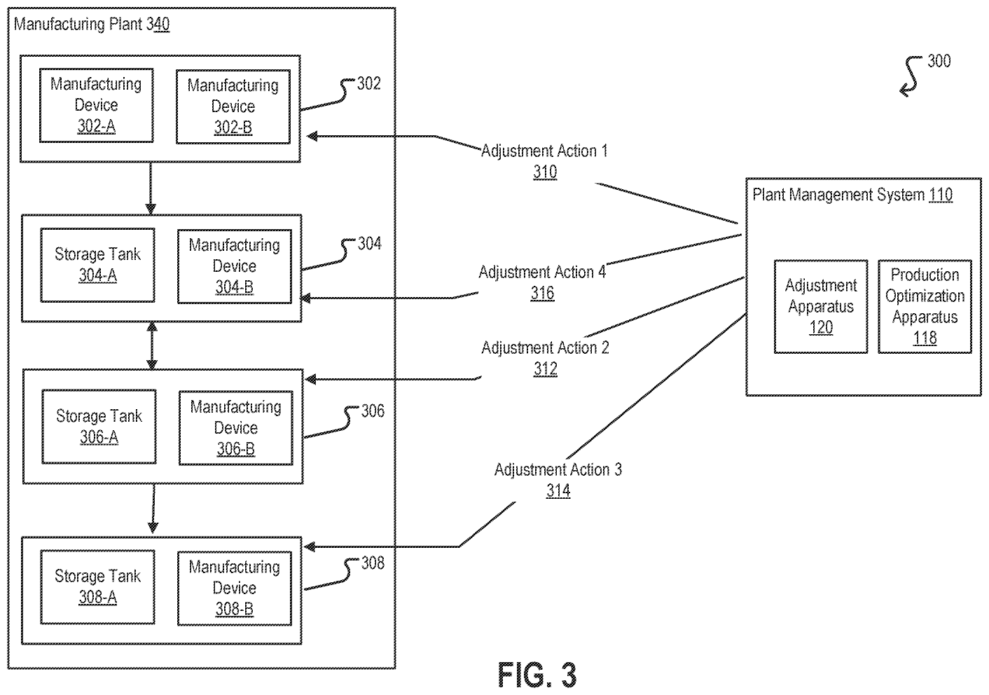

Manufacturing plant 140 (which is also referred to as a “plant” in this specification) is an industrial site at which goods, products, or other materials are manufactured, produced, or otherwise processed. In general, a manufacturing plant includes multiple plant devices 142-A and 142-B, which can include manufacturing devices (which are also referred to in this specification as machines) (e.g., digesters, pumps, paper machines, etc.) that are used in the manufacturing/production process as well as other devices that are necessary for the plant's operations (e.g., control systems, networking apparatus, electrical framework, etc.). Although the manufacturing plant 140 illustrated in FIG. 1 includes two plant devices 142-A and 142-B, manufacturing plants can include any number and type of devices (as described further with reference to FIG. 3) that are required to perform the appropriate manufacturing/production processes of the plant 140.

A number of different sensors (e.g., motion sensors, power meters, flow meters, thermometers, pressure sensors, etc.) can be dispersed throughout the plant 140. As shown in FIG. 1, plant devices 142-A and 142-B include (i.e., on the device or in its vicinity) a sensor 144. In addition, the plant 140 includes a sensor 144 that is not included on or in the vicinity of any device. Although three sensors are shown in FIG. 1, the plant 140 can include any number of sensors dispersed throughout the plant.

The example environment 100 also includes one or more operator devices 130. An operator device 130 is an electronic device that an operator of the plant 140 uses to, e.g., access operations of the plant, generate reports based on data (e.g., reports showing set point values of plant devices for a particular plant optimization as determined upon running simulations (which is further described below)) stored in the plant management system 110 (as described below), and to initiate or schedule actions that result in effecting control over certain aspects of the plant 140 (e.g., instructions specifying adjustments to be made to certain operational characteristics of the devices in the plant 140). Example operator devices 130 include personal computers, tablet devices, mobile communication devices, digital assistant devices, augmented reality devices, and other devices that can send and receive data over the network 104. An operator device 130 typically includes a user application, such as a web browser, to facilitate the sending and receiving of data over the network 150, but native applications executed by the user device 130 can facilitate the sending and receiving of content over the network 150.

The example environment 100 also includes a plant management system 110, which generally monitors and controls the operations of the different plant devices (142-A, 142-B) of the plant 140. The plant management system 110 obtains data from the different sensors 144 in the manufacturing plant 140. Data from the sensors can be transmitted via a communication interface (such as Bluetooth or other nearfield communication interface) to a sensor data manager 146 (which can include a wireless gateway) within the plant 140. The sensor data manager 146 consolidates the sensor data received from the different sensors 144 and then transmits this consolidated sensor data to the plant management system 110.

The plant management system 110 includes one or more front-end servers 112 and one or more back-end servers 114. The front-end servers 112 can transmit data to, and receive data from, operator devices 130 over the network 150. For example, the front-end servers 112 can provide, to an operator application 132 executing on an operator device 130, interfaces or data for presentation with the interfaces. The front-end servers 112 can also receive data specifying operator's interactions with the interfaces of the application 130. The front-end servers 112 can update the interfaces, provide new interfaces, and/or update the data presented by the interfaces based on user interactions with the application 132.

The front-end servers 112 can also communicate with the back-end servers 114. For example, the front-end servers 112 can identify data that is to be processed by the back-end servers 114, e.g., data specifying operational characteristics of plant devices, and provide the identified data to the back-end servers 114. The front-end servers 112 can also receive data from the back-end servers 114, e.g., data regarding current operational states of different manufacturing devices or summary of data simulated for different devices in a plant, and transmit the data to the operator device 130 over the network 150.

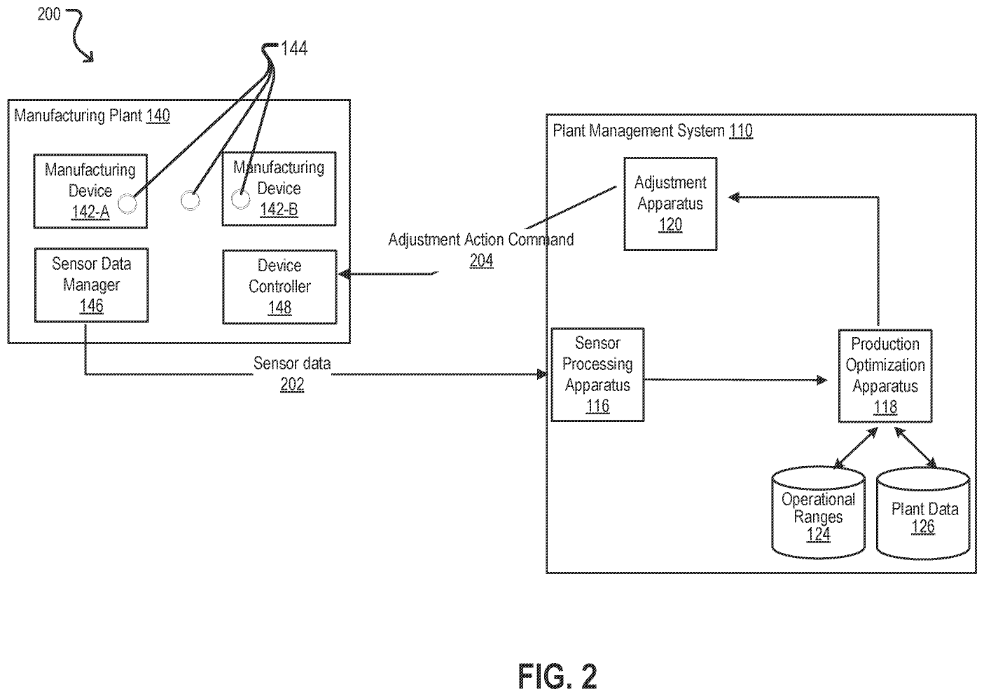

The back-end servers 114 include a sensor processing apparatus 116, a production optimization apparatus 118, and an adjustment apparatus 120. The operations of these apparatuses are summarized below and described in detail with reference to FIGS. 2 and 3.

The sensor processing apparatus 116 processes the sensor data that is received from the sensor data manager 146 and stored in the sensor data storage device 122. The sensor processing apparatus processes the sensor data to determine the operational characteristics for the different plant devices 142-A and 142-B. In some implementations, the sensor processing apparatus also obtains operational specifications (i.e., specified operational ranges) for the different plant devices from the operational ranges storage device 124 and, in some implementations, can use this data to identify plant devices that are operating outside their specified operational ranges. The processed sensor data, including the identified operational characteristics and the identification of out-of-specification operational characteristics, can be stored in the sensor data storage device 122. Alternatively, this information can be transmitted to the production optimization apparatus 118. Each of the storage devices-sensor data storage device 122, operational ranges storage device 124, and the plant data 126 storage device—is a non-transitory computer readable medium that can include one or more databases or other data structures.

The production optimization apparatus 118 determines operational characteristics for one or more plant devices that satisfy certain overall operational parameters (as further described below), e.g., for the one or more plant devices or for the plant as a whole. As summarized below and as further described below with reference to FIGS. 2 and 3, the production optimization apparatus 118 obtains the current operational characteristics data for different plant devices (received from the sensor processing apparatus 116 or retrieved from the production optimization apparatus 118) along with additional operational data and constraints about the plant received from the plant data storage device 126 (e.g., plant devices' operational ranges, a plant's operational or production capacity, actual and expected degradations in plant device efficiency, actual and expected manufacturing plant shutdowns).

The production optimization apparatus 118 uses this information in simulating different manufacturing scenarios to identify a particular manufacturing scenario that achieves one or more desired overall operational requirement (also referred to as overall operational parameters). As used in this specification, an overall operational requirement is a metric that specifies a target operational state or characteristic of/for one or more plant devices and/or the plant as a whole.

Examples of overall operational requirements/parameters, which can be specified for one or more plant devices and/or the plant as a whole, include Freeze Production, Stabilize, Maximize, Externally Planned, and Free within Limits. When the overall operational requirement is Freeze Production, the production set point (e.g., production/manufacturing rate) for one or more plant devices is to be maintained for a certain specified duration. When the overall operational requirement is Stabilize, the production set point (e.g., production/manufacturing rate) for one or more plant devices is to be maintained as stable as possible for a certain specified duration, i.e., by reducing the number of set point changes in the specified duration. When the overall operational requirement is Maximize, the production set point (e.g., production/manufacturing rate) for one or more plant devices is to be maximized for a certain specified duration while maintaining the overall production stable. This operational requirement is generally specified for plant devices towards the end of a production line (e.g., in a pulp processing plant, this operational requirement may be specified for a pulp dryer). When the overall operational requirement is Externally Planned, the production set point for one or more plant devices is specified by other systems (e.g., by enterprise resource planning (ERP) systems)). When the overall operational requirement is Free within Limits, the production set point for one or more plant devices can be set and/or altered/adjusted within the specified limits and for all or part of the specified durations. Additional examples of overall operational parameters/requirements are provided as follows. As one example, an overall operational parameter includes a target manufacturing output that specifies the expected manufacturing output for a plant or a device. As another example, an overall operational parameter can be an overall flow rate that specifies the average flow rate of the different plant devices in the plant.

Based on the identified particular manufacturing scenario and the corresponding operational characteristics, the adjustment apparatus 120 determines an adjustment action plan, which can include current adjustments to the operational characteristics of one or more plant devices (e.g., reduce operational speed, increase power draw, etc.) and/or scheduled adjustments to one or more plant devices (e.g., order replacement parts, schedule replacement). In some implementations, the adjustment apparatus 120 sends, for approval and over the network 150, the adjustment action plan to an operator device 130, which in turn can respond by confirming or denying the adjustment action plan. If the adjustment action plan is confirmed/approved by an operator operating the operator device, a plant device operator in conjunction with device controller can apply the specified adjustments to one or more plant devices, as specified by the adjustment action plan. Alternatively, instead of first sending the adjustment action plan for approval to the operator device 130, the adjustment apparatus 120 can directly send the adjustment action plan to a plant device operator who can review and apply (apply in conjunction the device controller) the specified adjustments to one or more plant devices, as specified by the adjustment action plan.

In some implementations, the plant device operator can operate and/or interact with a device controller 148 to implement the adjustment action plan, which includes transforming the adjustment actions into appropriate signals and/or messages that are sent (e.g., digitally or electrically) to one or more identified plant devices, which in turn use these signals to adjust (e.g., by flipping switches, rotating knobs, or activating/controlling other digital controls) one or more operational characteristics of the identified device.

FIG. 2 is a block diagram 200 illustrating the components of FIG. 1 that operate together to determine adjustments to one or more plant devices that results in maintaining and/or exceeding an overall plant operational requirement.

As shown in FIG. 2, the sensors 144 located throughout the plant 140 constantly, periodically (e.g., every second, every minute, every five minutes, every hour, etc.), or upon operator requests to record data, record data (e.g., current production data and/or set points for various plant devices, flow rate for plant devices, etc.). As described with reference to FIG. 1, each sensor transmits this data to the sensor data manager 146, which collects/aggregates the data received from different sensors across the plant in a set of sensor data 202. The sensor data manager 146 transmits the set of sensor data 202 to the plant management system 110.

In some implementations, the sensor data 202 identifies the sensor with which each respective data item is associated. For example, the data originating from each sensor can include metadata in the form of a tag that uniquely identifies the sensor (e.g., “Sensor ID=32114”) that recorded that data. Accordingly, all or portions of the set of sensor data 202 can also be delineated based on the tags that uniquely identify the sensor.

Each sensor in the plant 140 is associated with (i.e., assigned to) at least one plant device. For example, a sensor located on or near a particular plant device can be assigned to this plant device. In some implementations, sensors may be assigned to a single plant device, a subset of plant devices in the plant 140, or all the devices of the plant 140. For example, a flow rate sensor may also be assigned to a subset of devices when it measures the flow rate through this subset of devices. As another example, a power sensor may be assigned to all devices of the plant when it measures the overall power draw by the plant's devices.

An operator of the plant 140 can configure the plant management system 110 to store, e.g., in a database such as the sensor data storage device 122 and/or a cloud services system, the associations between different sensors and the plant devices (and in some cases, the components of the plant devices as well) (as described above). As a result, when the sensor data 202 is received from the plant 140, the plant management system 110 can use the received sensor identifier to look up the associated/assigned plant device/s (and in some case, the associated components of these devices) corresponding to the sensor data. Once the device/s (and component/s) associated with (i.e., assigned to) the received sensor data is/are identified, the plant management system 110 routes the set of sensor data 202 to the sensor processing apparatus 116.

The sensor processing apparatus 116 processes the sensor data 202 to determine current or expected operational characteristics of the plant device/s associated with the sensors. In some implementations, a lookup table can include relationships between different sensor data and operational characteristics for the device. The sensor processing apparatus 116 can use the sensor data for a particular device to identify the corresponding operational characteristics for this device from the lookup table. The lookup table can include a one-to-one association between a type of sensor data (e.g., flow rate), the actual sensor data, and an operational characteristic of the corresponding device. In some implementations, the lookup table can include a many-to-one association between different types of sensor data and an operational characteristic of the device. In some implementations, the lookup table can include a many-to-many association between different types of sensor data and operational characteristics of the device.

In some implementations, the sensor data for a particular sensor associated with a particular device may need to be processed/computed before the lookup table is accessed to determine the operational characteristic of the device. For example, the sensor processing apparatus 116 may first convert the vibration data received from a sensor located on a particular manufacturing device into a vibration or sound signature, which can include, e.g., analyzing one or more frequencies, amplitudes, or phase information at a particular snapshot in time or over certain time intervals. In this example, the sensor processing apparatus 116 may use this vibration or sound signature to identify, using the lookup table, the corresponding operational characteristic of operational speed. As another example, the sensor processing apparatus 116 may convert a power measurement received from a power sensor into a percentage of maximum power, which in turn can be mapped using a lookup table to an operational characteristic of a plant device's overall power output. In some implementations, the sensor data for a particular sensor is already in a form that can be used to directly identify, using the lookup table, the corresponding operational characteristics of a device. For example, the format of data received from a digital power sensor may be in the same form as the corresponding power sensor data stored in the lookup table.

In some implementations, instead of a lookup table, a model (e.g., a machine learning model, such as a neural network) can be used to determine operational characteristics of a device based on input sensor data for that device. In the case of a machine learning model, the model can be trained using known associations between sensor data and operational characteristics. Once trained, the model can accept as input sensor data for a device/component and output the corresponding operational characteristics of the device. Such a model-based approach may be desirable when the number of sensors, devices/components, and their various associations are numerous and can vary by device, component, and/or sensor. A person of ordinary skill in the art would understand that multiple other functions and/or models can be used to derive/determine the operational characteristics for a plant device (which is also simply referred to as device in this specification) based on the associated sensor data for that device.

Using the determined operational characteristics of the devices, the sensor processing apparatus 116 can determine whether one or more plant devices are operating out-of-specification. As used in this specification, an out-of-specification device refers to a device that has one or more operational characteristics that are outside the range of acceptable operational characteristics values, where the acceptable operational characteristics can be specified by device manuals and/or a plant administrator. Specifically, for each device, the sensor processing apparatus 116 identifies the acceptable operational range for a particular operational characteristic of that device. The operational ranges storage device 124 stores the acceptable operational ranges for different operational characteristics of plant devices. Thus, the sensor processing apparatus 116 uses the particular device and its determined operational characteristics to identify, from the operational ranges storage device 124, the corresponding acceptable operational ranges for that particular operational characteristic of the device. If the determined operational characteristic is within the acceptable operational range (identified from the operational ranges storage device 124), the sensor processing apparatus 116 determines that the device's operation is acceptable. If, however, the determined operational characteristic is not within the acceptable operational range (identified from the operational ranges storage device 124), the sensor processing apparatus 116 determines that the device is out of specification. When an operational characteristic is determined to be out of specification, the sensor processing apparatus 116 identifies this operational characteristic, the variance in the operational characteristic (from the normal range), and the corresponding device. In some implementations, this information can be stored in the operational ranges data storage device 124.

A production optimization apparatus 118 determines, based on various simulations, operational characteristics for one or more plant devices that satisfy one or more overall operational parameters/requirements. In implementations where the overall operational parameter is Maximize (as described above), the production optimization apparatus determines operational characteristics of one or more plant devices that maximize the production output of the one or more plant devices (and/or for the plant as a whole). In such implementations, the production optimization apparatus executes various simulations that vary operational characteristics of different plant devices to identify a set of operational characteristics for one or more plant devices that maximizes the plant's (or the various plant devices') overall production/manufacturing output.

In some implementations, before any adjustments are scheduled to be made to plant devices (e.g., performing service or repairs, changing a device's operational characteristic such as, e.g., to bring an out-of-specification device within specification, etc.), the production optimization apparatus 118 performs simulations to determine operational characteristics for plant devices for a certain duration that still satisfy the overall operational parameter (e.g., maximize production). For example, a plant operator (or other process) may determine that a particular manufacturing device is to be serviced/repaired, which would require taking the particular device offline for a certain duration. Making such an adjustment may inadvertently have a downstream impact of reducing the operational output of a critical downstream device (e.g., a plant device that performs its processing after or on the output of the present plant device). The simulations can help identify how various adjustments to one or more plant devices can be made to account for the planned shutdown of the particular plant device while still maximizing/stabilizing production output of the one or more plant devices (depending on the overall operational requirements/parameters that are to be satisfied).

The production optimization apparatus 118 simulates multiple manufacturing scenarios. Each manufacturing scenario includes a set of operational characteristics for one or more plant devices in the plant, and each manufacturing scenario is different from each other manufacturing scenario in that it uses a different set of operational characteristics for the one or more plant devices. In some implementations, a first manufacturing scenario includes the current operational characteristics for one or more plant devices that are determined by the sensor processing apparatus 116, and each other manufacturing scenario varies one or more of the currently-determined operational characteristics for the one or more plant devices. The variation in the operational characteristics across the different manufacturing scenarios can be randomly distributed across the different operational characteristics. Alternatively, the variation in the operational characteristics across the different manufacturing scenarios can be modeled using actual data about known manufacturing scenarios. Alternatively, the variation in the operational characteristics across the different manufacturing scenarios can be determined using a model (e.g., a machine learning model or another appropriate statistical model) that uses the desired plant overall operational requirement to assign more weight to particular operational characteristics over others and then generates operational characteristic data that is intended to have the most positive or negative impact on the desired plant overall operational requirement. In the instance when simulations are being run to assess the impact of an adjustment of one or more plant devices to the plant's operations, the simulations can maintain the desired adjustments as steady or fixed (i.e., not varied) across the different simulated manufacturing scenarios while varying all other operational characteristics.

In addition, the simulations also utilize additional data, in the form of device operational data and/or plant constraints, in computing the plant overall operational requirements. For example, the simulations can utilize plant operation data specifying constraints on the plant's manufacturing output or operations, such as the plant's maximum manufacturing/production capacity, the plant device's maximum and minimum production capacity, interrelationships/interconnections between various plant devices (e.g., a production device such as a digester interacts with and is connected to a storage device), and/or actual or expected plant or device shutdown(s).

Based on the sets of operational characteristics as well as the data about the device operational data and/or plant constraints, the production optimization apparatus 118 executes the simulations and computes values for one or more overall operational parameters/requirements (e.g., plant/device manufacturing output) for each manufacturing scenario. The various simulations can be executed using a simulator and optimization model, such as the Gurobi Optimizer or other optimization algorithms/models (e.g., that use machine learning techniques), that can simulate the various manufacturing scenarios to determine their respective impact on the plant/device production/manufacturing output (or other measureable production/manufacturing criteria or operating characteristics). As part of the simulation/optimization, the simulator and optimization model can use various weights to penalize certain activities/operational characteristics of plant device(s) and/or the plant as a whole. These weights are assigned, e.g., to certain activities/operational characteristics, such as: (1) number of shutdowns of one or more plant devices (or the plant as a whole), (2) duration of such shutdowns, (3) number of production rate changes for one or more plant devices, (4) deviations from target production rates for one or more plant devices or for the plant as a whole, (5) deviation from maximum production rates for one or more plant devices or for the plant as a whole, (6) exceeding limits for storage devices that are connected to certain plant devices (as shown in the example illustrated in FIG. 3), (7) duration during which production rate is non-zero for one or more plant devices or for the plant as a whole, and (8) total production of the plant and/or one or more plant devices. Although weights are described above as being assigned to only eight activities/plant device operational characteristics, more or less activities can be weighted as part of the optimization/simulation.

In some implementations, the weight values assigned to each of the above (or additional) activities can range from 0.0 to 1.0, with values closer to 0.0 (e.g., 0.1, 0.2) indicating that those activities are less penalized during the optimization, while values closer to 1.0 (e.g., 0.8, 0.9) indicating that those activities are more penalized during the optimization. In some implementations, instead of a range from 0.0 to 1.0, the range of weight values can be on any scale (e.g., 0 to 10, 0 to 100, etc.).

In some implementations, the weights for each of these (and other activities) are determined based on the overall operational parameters/requirements selected for one or more plant devices or for the plant as a whole. A rules engine (or another appropriate algorithm such as decision trees) can include a set of rules that specifies whether one or more of these weighted activities are to be penalized depending on the overall operational parameter/requirement. For example, if the overall operational parameter is Maximize, the rules engine can penalize (e.g., assign a weight greater than 0.5 to) the activity, such that when the plant device's actual production rate deviates from, and is less than, the maximum production rate for that device, that activity is penalized more relative to scenarios where the actual production rate is close to or at the maximum production rate. On the other hand, in this example, if the overall operational parameter/requirement is Free within Limits, the rules engine will not penalize this activity (e.g., by assigning a weight closer to 0.0) irrespective of the deviation between the actual production rate and the maximum production rate.

Similarly, and as another example, if the operational parameter is Maximize or Stabilize, the rules engine can penalize (e.g., assign a weight greater than 0.5) a duration of a device/plant shutdown, a number of device/plant shutdowns, or production rate changes. On the other hand, in this example, if the overall operational parameter is Free within Limits, the rules engine will not penalize this activity (e.g., by assigning a weight closer to 0.0).

At least in this manner, based on the sets of operational characteristics as well as the data about the device operational data and/or plant constraints, the production optimization apparatus 118 uses the simulation and optimization model along with the various weights that are based on the overall operational parameters, to execute the simulations and compute values for one or more plant production/manufacturing data/attributes/characteristics (e.g., plant/device(s) production rate, production output, or other measurable manufacturing/production attribute) for each manufacturing scenario.

The simulator and optimization model then identifies the simulated manufacturing scenario from among the various simulated manufacturing scenario that satisfies the overall operational parameter specified by the operator. For example, if the overall operational parameter is Maximize, the production optimization apparatus 118 selects a simulated manufacturing scenario for which the plant's or one or more device's manufacturing/production output is maximized (i.e., is the greatest/highest as compared to the plant's or the one or more device's manufacturing/production output for other simulated scenarios). For the identified manufacturing scenario, the production optimization apparatus 118 determines the corresponding operational characteristics for the one or more plant devices as utilized in the manufacturing scenario.

Using the identified operational characteristics for the one or more plant devices, the adjustment apparatus 120 generates an adjustment action plan, which specifies an adjustment action for one or more plant devices. As used in this specification, an adjustment action is a command or an instruction that specifies the adjustment of an operational characteristic of a plant device. For example, the adjustment apparatus 120 can include a lookup table storing a mapping between a plant device's operational characteristics and the corresponding adjustment action for the plant device. Thus, the adjustment apparatus uses the lookup table to identify, for the identified operational characteristics for the one or more plant devices, the corresponding plant device adjustment actions. Alternatively, the adjustment apparatus 120 can implement a model (e.g., a machine learning model or another appropriate statistical model) that is trained on known device operational characteristics and corresponding device adjustment actions, and that identifies device adjustment actions for the identified operational characteristics for the one or more plant devices. Note that due to the number of devices that are in a typical manufacturing plant, the high number of variables that change each time an adjustment is made to each specific device, and the potential ripple effects of changes to one device throughout the plant, the number of potential outcomes for any given change to a plant device can be very large (e.g., thousands or even millions). Also, the time within which changes to plant equipment may need to be changed can be very small (e.g., 1 minute, 5 minutes, or some other amount of time). As such, it is not feasible for a person to calculate all of the possible outcomes for every device that will be effected by various proposed changes, and select the appropriate adjustment action based on the possible outcomes.

Once the adjustment apparatus 120 determines a particular adjustment action for one or more plant devices, it transmits this adjustment action command 204, via the network 150, to the device controller 148. For example, an adjustment action can be an instruction to reduce the operational speed of a motor of a plant device. As another example, an adjustment action can be an instruction to adjust the power draw of a plant device.

A human operator uses the device controller 148 to parse the received adjustment action command 204 to identify the device/s for which adjustments need to be made and the corresponding adjustments for these devices. The human operator in conjunction with the device controller 204 can generate instructions that convert the adjustment action for each identified device into an electrical/digital signal that can be processed by the respective plant devices. For example, if the device adjustment action requires the motor speed of a manufacturing device to be increased by 50%, the human operator in conjunction with the device controller 204 can generate instructions to send a signal to the plant device 142-A, e.g., specifying the frequency of the motor that corresponds to a 50% increase to the current operational speed. Upon receiving this signal, the plant device adjusts the specified operational characteristic (e.g., adjusting operational frequency or rotational speed of a motor) by adjusting controls (e.g., changing physical positions of mechanical components, e.g., knobs, levers, and/or modifying settings for electric or digital components) of the manufacturing device. Further adjustments can include an instruction that results in a physical manipulation of some component on the manufacturing device (e.g., causing a motor or a robot to move a particular lever or knob).

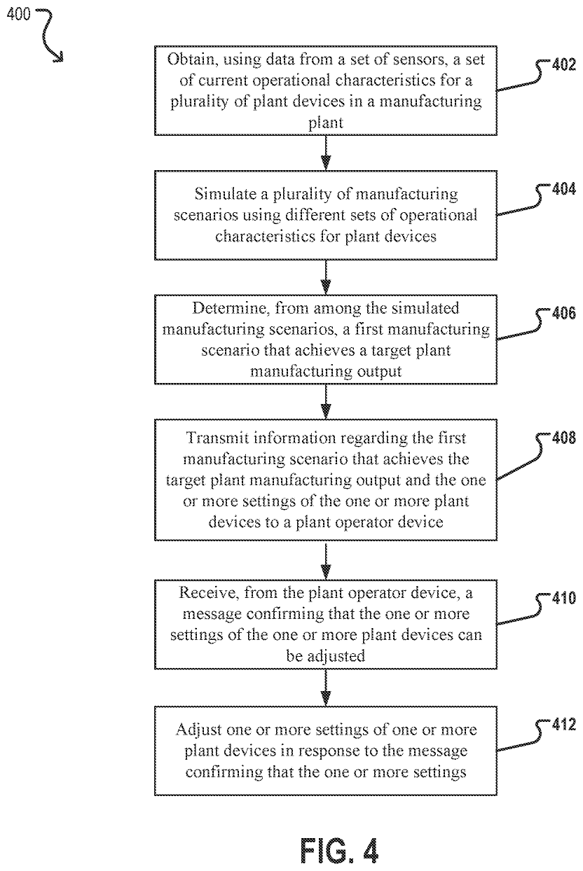

In some implementations, the above-described data analyzed and processed by the production optimization apparatus 118 and the adjustment apparatus 120 can be stored with a reference to each other in a storage device. The plant management system 110 can use this data to generate visualizations that are presented in applications executing on the operator's device 130. For example, the generated visualizations can provide text and/or graphs (or other graphical information) that use this data to provide operational, simulation, and adjustment reports specifying the current operational characteristics of the device, current operation data of the plant, optimization opportunities, and the adjustment action. An example of such a visualization is shown and described with reference to FIG. 4. Additionally, or alternatively, the data can trigger an alert or alarm indicating the need to take a specific action (e.g., flashing a light and/or emitting a sound corresponding to a specific condition or action).

FIG. 3 is a block diagram of an example environment 300 in which the plant management system 140 optimizes operations of a plant 340 based on a future event that could affect plant operations.

Plant 340 is a type of manufacturing plant that is described with reference to FIG. 1. The general design and organization of plant 340 is described as follows. Plant 340 is organized in five sections or areas: Area 1 (302), Area 2 (304), Area 3 (306), and Area 4 (308). Each section or area includes a set of plant devices. As shown in FIG. 3, Area 1 (302) includes two devices: manufacturing device 302-A and manufacturing device 302-B; Area 2 (304) includes two devices: storage tank 304-A and manufacturing device 304-B; Area 3 (306) includes two devices: storage tank 306-A and manufacturing device 306-B; and Area 4 (308) includes two devices: storage tank 308-A and manufacturing device 308-B.

Manufacturing plants are typically organized in sections/areas based on one or more factors, which can include, e.g., the operations (e.g., glazing, coating, folding, etc.) performed by a set of plant devices, the types of devices (e.g., pulpers, digesters, refiners, etc.), and the order in which operations are performed (e.g., pulping might be performed before refining). The output of the plant devices in one area/section are typically utilized by (and thus serve as inputs) for the plant devices in another area/section. As shown in FIG. 3, the output of the plant devices in Area 1 (302) is provided as an input to the plant devices in Area 2 (304). In some instances, the output of one section may serve as an input for a previous section. As shown in FIG. 3, the output of plant devices in Area 3 (306) is provided as an input to the plant devices in Area 2 (304). For example, a particular raw material may be processed and refined iteratively, such that after being processed and refined once, the process repeats on the refined version of the raw material until a certain condition is reached (e.g., a time or frequency of refining, quality of material, etc.). Although plant 340 is shown as including only five areas/sections with two plant devices per area/section, a manufacturing plant can, and typically does include, a large number of sections/areas and a large number of plant devices per section/area. For example, a manufacturing plant can include ten different sections/areas and those sections, on average, may have hundreds of plant devices.

Plant 340 may from time-to-time be subject to certain future events-both anticipated and unanticipated—that limit the overall manufacturing output of the plant 340. Examples of future anticipated events can include, among others, planned plant shutdowns and scheduled repairs/maintenance. Any such future event can have an adverse impact on a plant and/or its devices' operation and outputs.

To avoid an adverse impact on the plant's overall manufacturing output as a result of a future event (as described in the preceding paragraph), operations of plant devices in different areas/sections may need to be adjusted. For example, assume that a six-hour maintenance is scheduled for manufacturing devices in each of Area 1 (302) and Area 2 (304) within a certain period (e.g., within two days). In such an example scenario, the plant manufacturing output may be maintained by increasing operation speed (from 75% to 95%) for manufacturing devices 302-A and 302-B in Area 1 (302) to process enough raw material to completely fill the storage tank 304-A with the processed material. Upon completion of this task, plant devices in Area 1 can be taken offline for maintenance, while plant devices in Area 2 (304) and Area 3 (306) iteratively process and refine the materials in storage tank 304-A. When plant devices in Areas 2 and 3 (304 and 306) completely fill up the storage tank 308-A in Area 4 (308), manufacturing device 304-B in Area 2 is taken offline. At about the same time, manufacturing devices 302-A and 302-B in Area 1 are brought back online and operated at a speed/capacity that enables processing enough raw material to again fill up the storage tank 304-A by the time the maintenance of manufacturing device 304-B is scheduled to complete. Once maintenance is complete, all manufacturing devices can be returned to their original operational states, or otherwise adjusted.

For each future event, the types of adjustments, the timing for such adjustments, and the order in which adjustments need to be made to maintain manufacturing output can be very complex owing to the fact that a plant typically includes, e.g., a large number of areas/section (e.g., ten or more), a large number of plant devices per area/section (e.g., 100 or more), and a significant number of relationships between plant devices in one section as well as between sections. As such, adjustments to particular plant devices in a plant without consideration of the impact of such adjustments to other plant devices (in the present area and other areas) can not only fail to maintain the plant's manufacturing output, but in some instances, can also cause unintended damage to other plant devices, or other safety or operational hazards. Thus, an optimal adjustment action plan for different devices in the plant requires a consideration of a significant number of factors, parameters, and combinations. As such, generating an optimal adjustment action plan for the whole plant based on a future event is not feasible for a human plant operator.

The plant management system 110, on the other hand, can generate such an optimal adjustment plan using the production optimization apparatus 118 (the operations of which are described in detail with reference to FIG. 2 and are only summarized here). In particular, the production optimization apparatus 118 executes a large number of simulations that take as input the different plant operations (e.g., maximum input and output of a plant device, maximum total plant capacity, plant device storage volume, plant device processing time, etc.), the current operational characteristics of the different plant devices (e.g., current operational speed, power draw, etc.), the devices impacted by the future event (e.g., plant devices in Areas 1 and 2), and the nature of the impact (e.g., estimate plant device down time, estimated reduction in plant device output during maintenance, etc.). The resulting simulations (1) generate a set of manufacturing scenarios, with each scenario including a set of operational characteristics for different plant devices that may be varied over a certain time period (e.g., at time TO, set device 1 to 95% and device 2 to 90%; at time T1, set device 1 to 25% and device 2 to 98%), and (2) determine the impact of these operational characteristics on the plant's overall manufacturing output for that period. Based on the simulations and the various weights assigned to the simulation and optimization model (as described with reference to FIG. 2), the production optimization apparatus 118 identifies one simulated manufacturing scenario that satisfies the overall operational parameter (e.g., Stabilize), thus resulting in, e.g., maintaining the existing manufacturing output at or about the current manufacturing output level, notwithstanding the expected event (e.g., shutdown of one or more plant devices). Based on this identified manufacturing scenario and the corresponding set of operational characteristics for the different plant devices over time, the adjustment apparatus 120 determines adjustment actions for plant devices in different sections. As shown in FIG. 3, the adjustment apparatus 120 determines: Adjustment Action 1 (310) for plant devices in Area 1 (302), Adjustment Action 2 (312) for plant devices in Area 3 (306), Adjustment Action 3 (314) for plant devices in Area 4 (306), and Adjustment Action 4 (316) for plant devices in Area 2 (304).

In some implementations, the adjustment apparatus 120 can send all adjustment actions at the same time to the plant 340. In such implementations, the adjustment apparatus 120 can specify the order (including the timeline on which the adjustments are to be made and the operations that need to be performed after the adjustments have been made) in which these adjustments are to be applied to the different plant devices in the different plant sections. Using the order specified by the adjustment apparatus 120, a plant device operator in conjunction with a device controller (similar to device controller 148 in FIG. 1) can accordingly stage the adjustments to the different plant devices in the different plant sections. Alternatively, the adjustment apparatus 120 can send adjustments one at a time, and wait for the adjustment to be made and the operations at those adjustments to be completed, before sending another adjustment action. For example, the adjustment apparatus 120 can send adjustment action 1 (310) to the plant 340 and wait for an acknowledgement from the plant 340 (e.g., via the device controller) specifying that the adjustment has been made and the corresponding operations using that adjustment have been completed. In this example, upon receiving this acknowledgement, the adjustment apparatus 120 then sends the next adjustment action (adjustment action 2 (312)) to the plant 340, and so on. In some implementations, the adjustment action can also specify if any adjustments need to be made after the operations have been completed (e.g., to turn off power to one or more devices—as in the case of taking a plant device offline for maintenance).

FIG. 4 is a flow chart of an example process 400 for determining adjustments to one or more plant devices that results in maintaining and/or exceeding an overall plant operational requirement. Operations of the process 400 can be implemented, for example, by the system components shown in FIGS. 1-3, and/or one or more data processing apparatus. In some implementations, operation of the process 400 can be implemented as instructions stored on a non-transitory computer readable medium, where execution of the instructions by one or more data processing apparatus cause the one or more data processing apparatus to perform operations of the process 400.

The sensor processing apparatus 116 obtains, using data from a set of sensors, a set of current operational characteristics for a plurality of plant devices in a manufacturing plant (402). As described above with reference to FIGS. 1-3, the sensor processing apparatus 116 receives sensor data from a set of sensors (e.g., sound sensors, vibration sensors, flow rate sensors, etc.), and this sensor data is consolidated and transmitted as a single set of sensor data 202 to the plant management system 110. The sensor processing apparatus 116 (of the plant management system 110) processes this sensor data to determine operational characteristics of different plant devices in the manufacturing plant.

The production optimization apparatus 118 simulates a plurality of manufacturing scenarios using different sets of operational characteristics for plant devices (404). As described above with reference to FIGS. 1-3, the production optimization apparatus determines operational characteristics for one or more plant devices that satisfies one or more overall operational parameters for one or more plant devices or for the plant as a whole. As described above with reference to FIGS. 1-3, the production optimization apparatus 118 obtains the current operational characteristics data for different plant devices (received from the sensor processing apparatus 116 or retrieved from the production optimization apparatus 118) along with additional operational data and constraints about the plant received from the plant data storage device 126 (e.g., plant devices' operational ranges, a plant's operational or production capacity, actual and expected degradations in plant device efficiency, actual and expected manufacturing plant shutdowns, and a total plant risk assessment specifying a total risk to operations or production of the manufacturing plant). The production optimization apparatus 118 uses this information in simulating different manufacturing scenarios to identify a particular manufacturing scenario that satisfies one or more overall operational parameters for one or more plant devices or for the plant as a wholes. The details about the types of simulations and how and when these simulations are executed are described in detail with reference to FIGS. 2 and 3.

The production optimization apparatus 118 determines, from among the simulated manufacturing scenarios, a first manufacturing scenario that satisfies one or more overall operational parameters for one or more plant devices or for the plant as a whole (406). From among the various simulated manufacturing scenarios, the production optimization apparatus 118 identifies the manufacturing scenario that satisfies (or is closest to satisfying) the plant overall operation parameter (e.g., when the overall operational parameter is Maximize, the production optimization apparatus 118 may select the simulated scenario that results in the greatest plant production output or device production output), as described in greater detail with reference to FIGS. 2 and 3.

The plant management system 110 transmits information regarding the first manufacturing scenario that achieves the target plant manufacturing output and the one or more settings of the one or more plant devices to a plant operator device (408). As described above with reference to FIGS. 1-3, the production optimization apparatus 118 identifies the one or more operational characteristics corresponding to the identified manufacturing scenario. Using these operational characteristics, the adjustment apparatus 120 identifies one or more adjustments (which are also referred to as settings in this specification) to one or more plant devices (as described above with reference to FIGS. 1-3). The plant management system 110 transmits, in a message to the operator of the operator device 130, the information about the identified manufacturing scenario, the identified operational characteristics, and the corresponding adjustments to the one or more plant devices.

The plant management system 110 receives, from the plant operator device, a message confirming that the one or more settings of the one or more plant devices can be adjusted (410). As described above with reference to FIGS. 1-3, the operator device 130, upon receiving the message sent as per operation 408, presents this message to a plant operator in an operator application executing on the operator device 130. In addition to providing the information included in the message, the message can also include options for the operator to confirm or deny the specified adjustments from being applied to the plant devices identified in the message. Alternatively, or in addition, the operator may be able to specify alternative adjustments to be applied to one or more plant devices. If the operator denies the specified adjustments, a message is sent by the operator device 130 and received by the plant management system 110, which in turn sends a command to the adjustment apparatus 120 to not apply the determined adjustments. Alternatively, if the operator confirms the specified adjustments (or specifies alternative adjustments to one or more of the identified plant devices), a message is sent by the operator device 130 and received by the plant management system 110, which in turn sends a command to the adjustment apparatus 120 to apply the determined (or operator specified) adjustments. In some implementations, the message sent at operation 408 may only include information about a subset of the adjustments for which operator approval is required (e.g., where high criticality adjustments are being made or adjustments are being made to highly critical or sensitive plant devices). In such implementations, the subset of the adjustments for which operator approval is not required are transmitted to the device controller 148 and the subset for which operator approval is required are transmitted to the device controller 148 only upon receiving operator confirmation (as further described with reference to operation 412).

The adjustment apparatus 120 adjusts one or more settings of one or more plant devices in response to the message confirming that the one or more settings (412). As described above with reference to FIGS. 1-3, the adjustment apparatus 120 determines the appropriate adjustments for one or more plant devices based on the identified manufacturing scenario and the corresponding operational characteristics for the identified one or more plant devices. The adjustment apparatus 120 sends an adjustment action command 204 (which includes the determined adjustment actions or the operator specified adjustments) to the plant device operator, which in conjunction with the device controller 148 of the plant, generates instructions that transmit appropriate signals to the plant devices identified in the adjustment action command 204 to effect the corresponding updates to the plant device/s' operations.

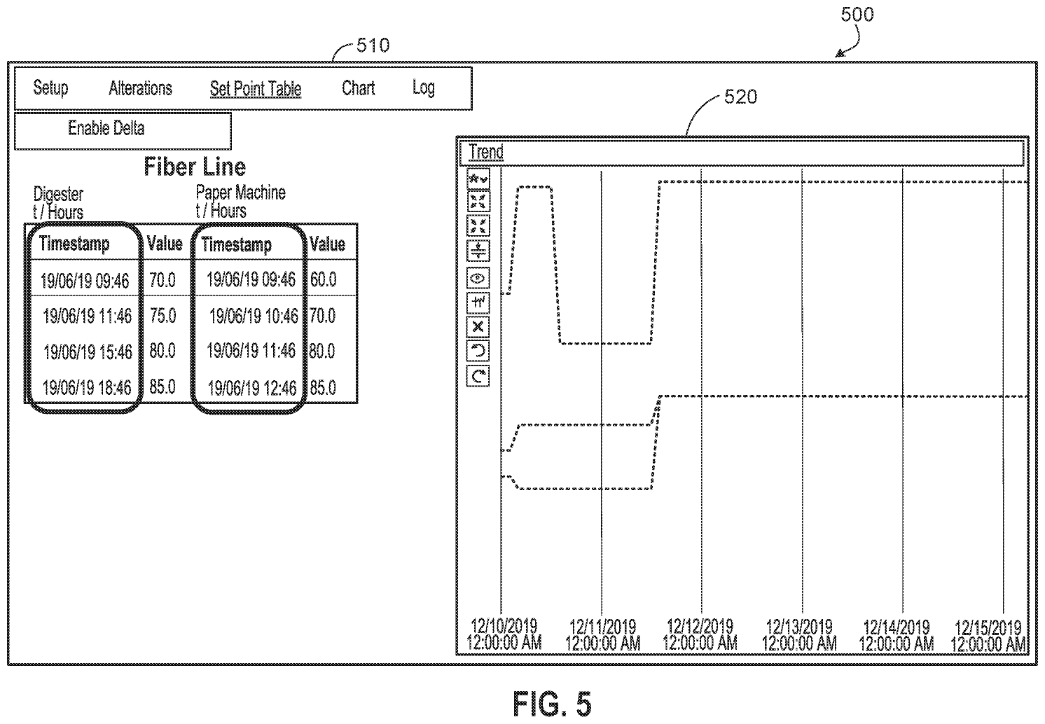

FIG. 5 is an example user interface visualization 500 that is generated for presentation on an operator device 130.

The front end server 112 of the plant management system 110 generates the visualization 500 based on the data analyzed and processed by the plant management system 110 (as described above with reference to FIGS. 1-4). The visualization 500 include a set point table 510 that specifies the set points/operational characteristics that are determined to be optimal based on the executed simulations. Visualization 500 also includes a graph 520 showing the actual and expected manufacturing output over time, with and/without the adjustments determined (as described above with reference to FIGS. 1-3).

In some implementations, the visualization 500 can include additional numerical data about the manufacturing scenario identified by the production optimization apparatus 118 that satisfies the overall operational parameters/requirements. In some implementations, the visualization 500 can include an identification of the current manufacturing output, the overall operational parameters/requirements, the plant constraint that are accounted for in the simulation, and the recommended adjustment actions to the one or more plant devices.

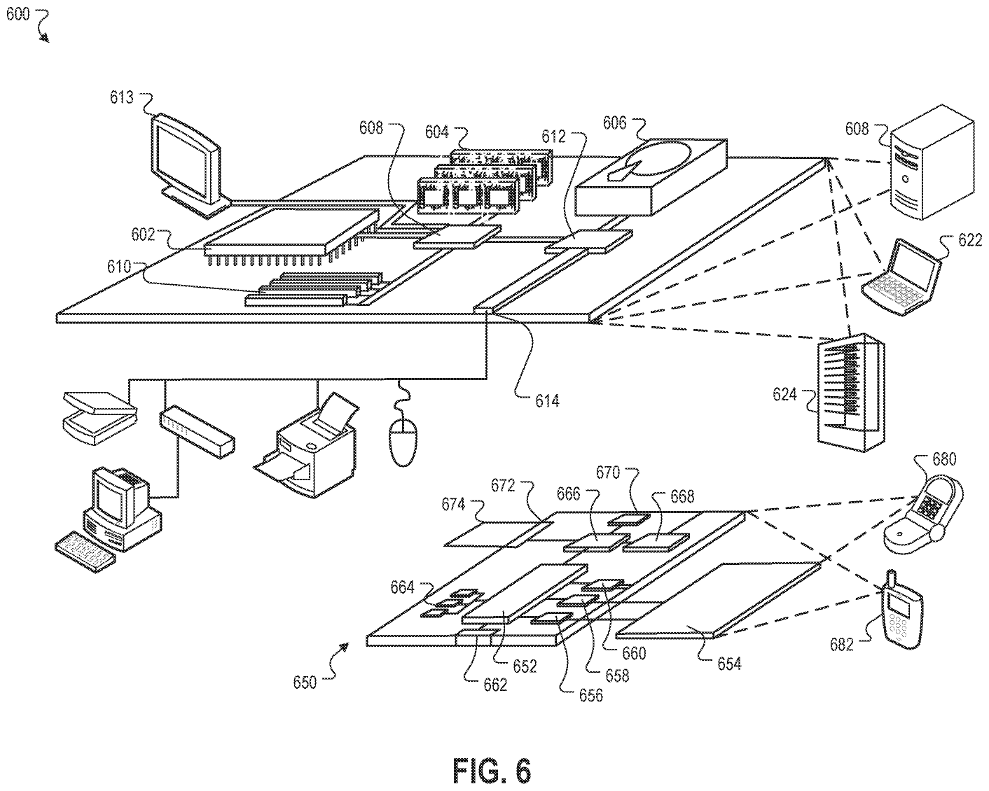

FIG. 6 is a block diagram of computing devices 600, 650 that may be used to implement the systems and methods described in this document, either as a client or as a server or plurality of servers.

Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a computer-readable medium. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a computer-readable medium. In various different implementations, the storage device 606 may be a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, or memory on processor 602.

The high-speed controller 608 manages bandwidth-intensive operations for the computing device 600, while the low speed controller 612 manages lower bandwidth-intensive operations. Such allocation of duties is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD display or an OLED display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, to enable near area communication of device 650 with other devices. External interface 662 may provide, for example, for wired communication (e.g., via a docking procedure) or for wireless communication (e.g., via Bluetooth or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 may also be provided and connected to device 650 through expansion interface 672, which may include, for example, a SIMM card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provided as a security module for device 650, and may be programmed with instructions that permit secure use of device 650. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, Wi-Fi, or other such transceiver (not shown). In addition, GPS receiver module 670 may provide additional wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component such as an application server, or that includes a front end component such as a client computer having a graphical user interface or a Web browser through which a user can interact with an implementation of the systems and techniques described here, or any combination of such back end, middleware, or front end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

As used in this specification, the term “module” is intended to include, but is not limited to, one or more computers configured to execute one or more software programs that include program code that causes a processing unit(s)/device(s) of the computer to execute one or more functions. The term “computer” is intended to include any data processing or computing devices/systems, such as a desktop computer, a laptop computer, a mainframe computer, a personal digital assistant, a server, a handheld device, a smartphone, a tablet computer, an electronic reader, or any other electronic device able to process data.

A number of embodiments have been described. Nevertheless, it will be understood that various modifications may be made without departing from the spirit and scope of the invention. Accordingly, other embodiments are within the scope of the following claims. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

1. A computer implemented method, comprising:
obtaining, using data from a set of sensors, a set of current operational characteristics for a plurality of plant devices in a manufacturing plant;
simulating a plurality of manufacturing scenarios using different sets of operational characteristics for plant devices in which at least one operational characteristic from the set of current operational characteristics is varied;
determining, from among the simulated manufacturing scenarios, a first manufacturing scenario that satisfies one or more overall operational parameters for one or more plant devices or for the manufacturing plant as a whole; and
adjusting one or more settings of one or more plant devices based on a set of operational characteristics corresponding to the first manufacturing scenario.

2. The computer implemented method of claim 1, further comprising:
generating a visualization that presents the set of operational characteristics corresponding to the first manufacturing scenario.

3. The computer implemented method of claim 1, wherein simulating the plurality of manufacturing scenarios is based on one or more factors comprising:
a plant operational capacity;
operational ranges for plant devices;
actual and expected degradations in plant device efficiency; or
actual and expected manufacturing plant or plant device shutdowns.

4. The computer implemented method of claim 1, wherein determining, from among the simulated manufacturing scenarios, the first manufacturing scenario, comprises:
determining, from among the simulated manufacturing scenarios, the first manufacturing scenario that achieves a plant manufacturing output that is greater than plant manufacturing outputs achieved by other simulated manufacturing scenarios.

5. The computer implemented method of claim 1, further comprising:
transmitting information regarding the first manufacturing scenario that achieves the target plant manufacturing output and the one or more settings of the one or more plant devices to a plant operator device;
receiving, from the plant operator device, a message confirming that the one or more settings of the one or more plant devices can be adjusted; and
wherein adjusting one or more settings of one or more plant devices is only performed in response to the message confirming that the one or more settings of plant devices can be adjusted.

6. A system, comprising:
one or more memory devices storing instructions; and
one or more data processing apparatus that are configured to interact with the one or more memory devices, and upon execution of the instructions, perform operations including:
obtaining, using data from a set of sensors, a set of current operational characteristics for a plurality of plant devices in a manufacturing plant;
simulating a plurality of manufacturing scenarios using different sets of operational characteristics for plant devices in which at least one operational characteristic from the set of current operational characteristics is varied;
determining, from among the simulated manufacturing scenarios, a first manufacturing scenario that satisfies one or more overall operational parameters for one or more plant devices or for the manufacturing plant as a whole; and
adjusting one or more settings of one or more plant devices based on a set of operational characteristics corresponding to the first manufacturing scenario.

7. The system of claim 6, wherein the one or more data processing apparatus are configured to perform operations further comprising:
generating a visualization that presents the set of operational characteristics corresponding to the first manufacturing scenario.

8. The system of claim 6, wherein simulating the plurality of manufacturing scenarios is based on one or more factors comprising:
a plant operational capacity;
operational ranges for plant devices;
actual and expected degradations in plant device efficiency; or
actual and expected manufacturing plant or plant device shutdowns.

9. The system of claim 6, wherein determining, from among the simulated manufacturing scenarios, the first manufacturing scenario, comprises:
determining, from among the simulated manufacturing scenarios, the first manufacturing scenario that achieves a plant manufacturing output that is greater than plant manufacturing outputs achieved by other simulated manufacturing scenarios.

10. The system of claim 6, wherein the one or more data processing apparatus are configured to perform operations further comprising:
transmitting information regarding the first manufacturing scenario that achieves the target plant manufacturing output and the one or more settings of the one or more plant devices to a plant operator device;
receiving, from the plant operator device, a message confirming that the one or more settings of the one or more plant devices can be adjusted; and
wherein adjusting one or more settings of one or more plant devices is only performed in response to the message confirming that the one or more settings of plant devices can be adjusted.

11. A non-transitory computer readable medium storing instructions that, when executed by one or more data processing apparatus, cause the one or more data processing apparatus to perform operations comprising:
obtaining, using data from a set of sensors, a set of current operational characteristics for a plurality of plant devices in a manufacturing plant;
simulating a plurality of manufacturing scenarios using different sets of operational characteristics for plant devices in which at least one operational characteristic from the set of current operational characteristics is varied;
determining, from among the simulated manufacturing scenarios, a first manufacturing scenario that satisfies one or more overall operational parameters for one or more plant devices or for the manufacturing plant as a whole; and
adjusting one or more settings of one or more plant devices based on a set of operational characteristics corresponding to the first manufacturing scenario.

12. The non-transitory computer readable medium of claim 11, wherein the instructions cause the one or more data processing apparatus to perform operations comprising:
generating a visualization that presents the set of operational characteristics corresponding to the first manufacturing scenario.

13. The non-transitory computer readable medium of claim 11, wherein simulating the plurality of manufacturing scenarios is based on one or more factors comprising:
a plant operational capacity;
operational ranges for plant devices;
actual and expected degradations in plant device efficiency; or
actual and expected manufacturing plant or plant device shutdowns.

14. The non-transitory computer readable medium of claim 11, wherein determining, from among the simulated manufacturing scenarios, the first manufacturing scenario, comprises:
determining, from among the simulated manufacturing scenarios, the first manufacturing scenario that achieves a plant manufacturing output that is greater than plant manufacturing outputs achieved by other simulated manufacturing scenarios.

15. The non-transitory computer readable medium of claim 11, wherein the instructions cause the one or more data processing apparatus to perform operations comprising:
transmitting information regarding the first manufacturing scenario that achieves the target plant manufacturing output and the one or more settings of the one or more plant devices to a plant operator device;
receiving, from the plant operator device, a message confirming that the one or more settings of the one or more plant devices can be adjusted; and
wherein adjusting one or more settings of one or more plant devices is only performed in response to the message confirming that the one or more settings of plant devices can be adjusted.
